(19) United States
(12) Patent Application Publication
(10) Pub. No.: US 2023/0008627 A1
(43) Pub. Date: Jan. 12, 2023

(54) AIRCRAFT WING INSPECTION LIGHT WITH CAMERA

(71) Applicant: HONEYWELL INTERNATIONAL INC., Charlotte, NC (US)

(72) Inventor: Newel Stephens, Urbana, OH (US)

(73) Assignee: HONEYWELL INTERNATIONAL INC., Charlotte, NC (US)

(21) Appl. No.: 17/305,517

(22) Filed: Jul. 9, 2021

(51) Int. Cl. H04N 7/18; H04N 5/225; H04N 5/76; H04N 5/247; B64D 47/02; B64D 47/08; B64D 43/00; B64F 5/60

(52) U.S. Cl. CPC H04N 7/181; H04N 5/2252; H04N 5/2256; H04N 5/76; H04N 5/247; B64D 47/02; B64D 47/08; B64D 43/00; B64F 5/60

(57) ABSTRACT

An aircraft wing inspection system includes a housing, a light source, a camera, and a display device. The housing is adapted to be mounted on an aircraft fuselage. The light source is disposed within the housing and is operable, upon being electrically energized, to emit a light beam. The camera is disposed within the housing and is configured to capture images of the aircraft wing, convert the captured images to digital image data, and transmit the digital image data. The display device is disposed remote from, and is in operable communication with, the camera. The display device is configured to receive the digital image data transmitted from the camera and to render the captured images.

### TECHNICAL FIELD

The present invention generally relates to an aircraft wing inspection system, and more particularly relates to an aircraft wing inspection system that incorporates a camera into the wing inspection light.

### BACKGROUND

Aircraft operate in many different types of weather and conditions, including icing conditions. Under such conditions, ice may form over the leading edges of the wings and control surfaces of an aircraft. Typically, inspections for aircraft wing icing are conducted be direct visual inspection by the flight crew. Since the wings are not visible from the flight deck, a member of the flight crew must enter the passenger cabin to look out a window and inspect for wing icing. However, current procedures for most commercial airlines prohibit the flight crew from leaving the flight deck while the aircraft is in flight. As such, aircraft wing icing inspections can only be conducted when the aircraft is on the ground. While various techniques for detecting aircraft wing icing have been proposed, these techniques can be costly, require installing devices on the wings or in other areas on the aircraft, or both.

Hence, there is a need for a system that allows the flight crew to be able to conduct an aircraft wing icing inspection without leaving the cockpit, and that does not rely on relatively costly devices, nor requires installing additional devices on the wings or other areas on the aircraft. The present disclosure addresses at least these needs.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, an aircraft wing inspection system includes a housing, a light source, a camera, and a display device. The housing is adapted to be mounted on an aircraft fuselage. The light source is disposed within the housing and is operable, upon being electrically energized, to emit a light beam. The camera is disposed within the housing and is configured to capture images of the aircraft wing, convert the captured images to digital image data, and transmit the digital image data. The display device is disposed remote from, and is in operable communication with, the camera. The display device is configured to receive the digital image data transmitted from the camera and to render the captured images.

In another embodiment, an aircraft includes a fuselage, a first aircraft wing extending from the fuselage, a second aircraft wing extending from the fuselage, a first housing, a first light source, a first camera, a second housing, a second light source, a second camera, and a display device. The first housing is mounted on the fuselage. The first light source is disposed within the first housing and is operable, upon being electrically energized, to emit a first light beam toward the first aircraft wing. The first camera is disposed within the first housing and is configured to capture first images of the first aircraft wing, convert the captured first images of the first aircraft wing to first digital image data, and transmit the first digital image data. The second housing is mounted on the fuselage. The second light source is disposed within the second housing and is operable, upon being electrically energized, to emit a second light beam toward the second aircraft wing. The second camera is disposed within the second housing and is configured to capture second images of the second aircraft wing, convert the captured second images of the second aircraft wing to second digital image data, and transmit the second digital image data. The display device is disposed remote from, and is in operable communication with, the first and second cameras. The display device is configured to receive the first and second digital image data transmitted from the first and second cameras, respectively, and to render the first and second captured images.

Furthermore, other desirable features and characteristics of the aircraft wing inspection system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts an overhead view of one embodiment of an aircraft; and

FIG. 2 depicts a functional block diagram of one embodiment of an aircraft wing inspection system that may be implemented in the aircraft of FIG. 1.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

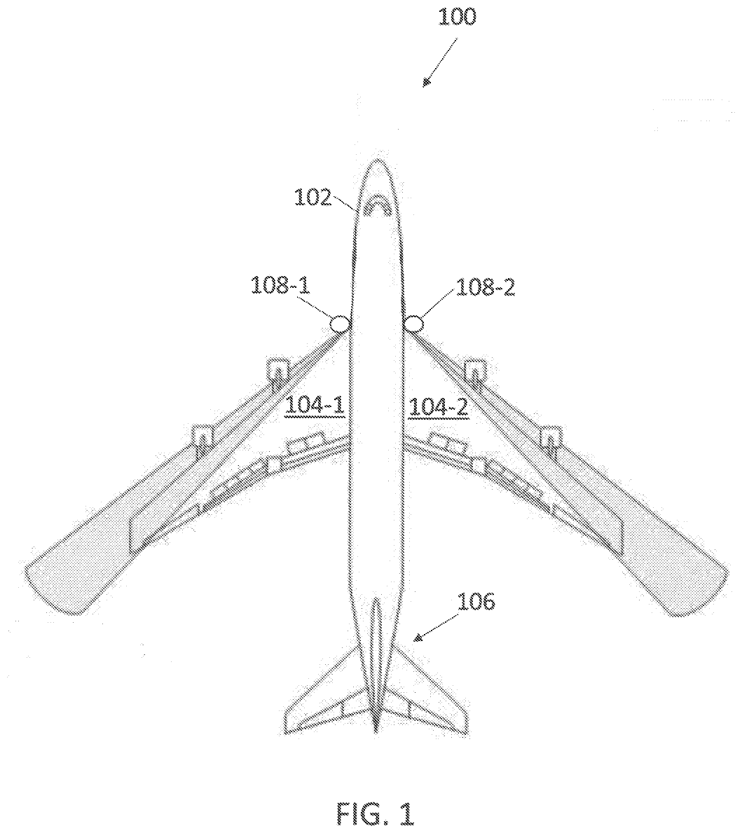

Referring to FIG. 1 top view of one embodiment of an aircraft 100 is depicted and includes a fuselage 102, a first aircraft wing 104-1, a second aircraft wing 104-2, and an empennage 106. The first and second aircraft wings 104-1, 104-2 extend from the fuselage 102, and the empennage 106 (or tail assembly) is disposed at the rear of the fuselage 102.

The aircraft 100 additionally includes a plurality of light sources, some of which are mounted on the fuselage. These light sources may include, for example, navigation lights, beacon lights, strobe lights, taxi lights, runway turnoff lights, and landing lights), just to name a few. The light sources may also include various inspection lights, such as the wing inspection lights depicted in FIG. 1. In particular, the depicted aircraft 100 includes a first wing inspection light 108-1 and a second wing inspection light 108-2. The first and second wing inspection lights 108-1, 108-2 are mounted on the fuselage 102 and, as depicted, are aimed to illuminate at least the leading edge of the first and second aircraft wings 104-1, 104-2, respectively. As may be appreciated, these lights 108-1, 108-2 may also illuminate the engine pylons.

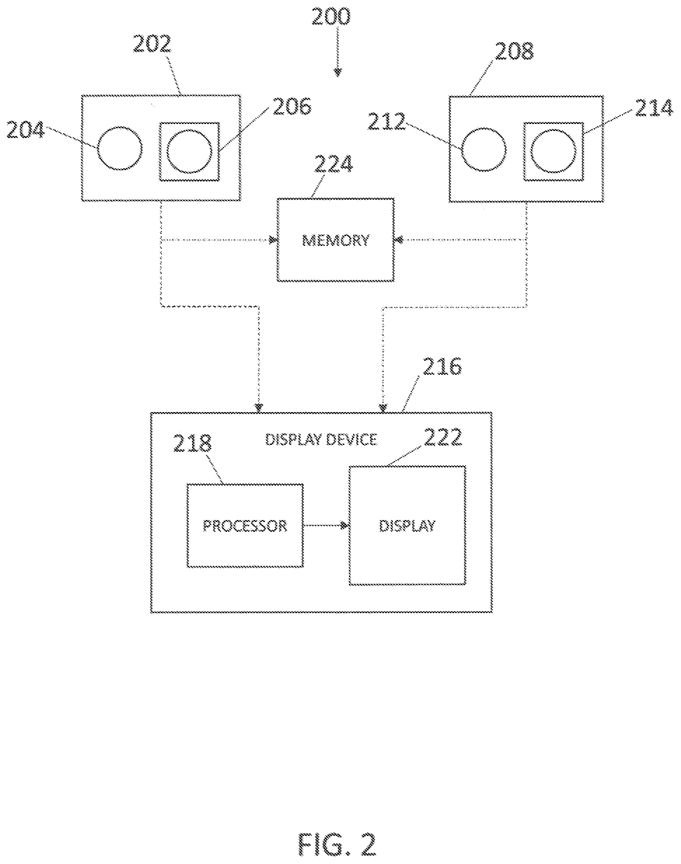

In addition to illuminating the leading edges of the aircraft wings 104-1, 104-2, the first and second wing inspection lights 108-1, 108-2 also form part of a wing inspection system. An embodiment of the wing inspection system 200 is depicted in FIG. 2, and with reference thereto will now be described.

The wing inspection system 200 includes a first housing 202, a first light source 204 (e.g., first wing inspection light 108-1), a first camera 206, a second housing 208, a second light source 212 (e.g., second wing inspection light 108-2), a second camera 214, and a display device 216. The first housing 202 is mounted on the fuselage 102, and the first light source 204 is disposed within the first housing 202. The first light source 204 is operable, upon being electrically energized, to emit a first light beam. More specifically, the first housing 202 and first light source 204 are disposed such that the first light beam is emitted toward the first aircraft wing 104-1.

The second housing 208 is also mounted on the fuselage 102, and the second light source 212 is disposed within the second housing 208. The second light source 208 is operable, upon being electrically energized, to emit a second light beam. More specifically, the second housing 208 and second light source 212 are disposed such that the second light beam is emitted toward the second aircraft wing 104-2.

Unlike known wing inspection lights, which would only have light sources disposed within the first and second housings 202, 208, the wing inspection system 200 described herein also has cameras disposed in the housings. That is, the first camera 206 is disposed within the first housing 202, and the second camera 214 is disposed within the second housing 208. The first camera 206 is disposed and configured to capture images (referred to herein as “first images”) of the first aircraft wing 104-1, and the second camera 214 is disposed and configured to capture images (referred to herein as “second images”) of the second aircraft wing 104-2.

The first and second cameras 206, 214 are also configured to convert the captured images to digital image data, and to transmit the digital image data. More specifically, the first camera 206 is configured to convert the captured first images of the first aircraft wing 104-1 to first digital image data, and to transmit the first digital image data. Similarly, the second camera 214 is configured to convert the captured second images of the second aircraft wing 104-2 to second digital image data, and to transmit the second digital image data. The first and second digital image data are transmitted to at least the display device 216. The first and second cameras 204, 214 may be implemented using any one of numerous types of cameras. For example, the cameras 204, 214 may be any one of numerous infrared (IR) cameras, visual cameras, or a camera that is a combination of both, just to name a few. If thermal cameras are used, the temperature of the wings can be determined and any ice that is present can be highlighted.

The display device 216 is disposed remote from, and is in operable communication with, the first and second cameras 206, 214. The display device 216 is configured to receive the first and second digital image data transmitted from the first and second cameras 206, 214, respectively, and to render the first and second captured images. To do so, and as FIG. 2 additionally depicts, the display device 216 includes at least a processor 218 and a display 222. The processor 218 is operable to receive the first and second image data and is configured, upon receipt of the image data, to command the display 222 to render images of the first and second captured images. The processor 218 may, in some embodiments, implement image processing software to detect and highlight ice or other undesirable conditions on the display 222.

Before proceeding further, it will be appreciated that the processor 218 may be any custom-made or commercially available processor, a central processing unit (CPU), a graphics processing unit (GPU), an application specific integrated circuit (ASIC), a field programmable gate array (FPGA), an auxiliary processor among several processors associated with the controller, a semiconductor-based microprocessor (in the form of a microchip or chip set), any combination thereof, or generally any device for executing instructions. It will additionally be appreciated that the display 222 may be any one of numerous types of head-up or head down displays, and may implemented as an electroluminescent (ELD) display, and liquid crystal display (LCD), a light-emitting diode (LED) backlit LCD, a thin-film transistor (TFT) LCD, a light-emitting diode (LED) display, an OLED display, and AMOLED display, a plasma (PDP) display, or a quantum dot (QLED) display, just to name a few.

Regardless of how the processor 218 and display 222 are specifically implemented, the display device 216 may be in operable communication with the first and second cameras 206, 214 via either a wired connection or a wireless connection. Moreover, the display device 216 may be permanently installed in the cockpit of the aircraft 100, and may thus form part of the avionics suite, or it may be a portable device, such as an electronic flight bag (EFB), a laptop computer, a tablet computer, or any one or numerous hand-held devices.

As FIG. 2 further depicts, the wing inspection system 200 may additionally include memory 224. The memory 224, when included, is coupled to receive and store the first and second digital image data. The stored image data may then be recalled at a later time, as needed or desired. It will be appreciated that the memory 224 may be disposed within the first and second cameras 206, 214, and thus be implemented as first and second memories. Conversely, the memory 224 may be disposed remotely from the first and second cameras 206, 214. In this latter instance, the memory 224 may be part of the display device 216, or it may be memory disposed remotely from display device 224 and even remotely from the aircraft 100.

The wing inspection system disclosed herein allows the flight crew to be able to conduct an aircraft wing icing inspection without leaving the cockpit. The system does not rely on relatively costly devices, nor does it require installing additional devices on the wings or other areas on the aircraft.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An aircraft wing inspection system, comprising:
a housing adapted to be mounted on an aircraft fuselage;
a light source disposed within the housing and operable, upon being electrically energized, to emit a light beam;
a camera disposed within the housing, the camera configured to (i) capture images of the aircraft wing, (ii) convert the captured images to digital image data, and (iii) transmit the digital image data; and
a display device disposed remote from, and in operable communication with, the camera, the display device configured to receive the digital image data transmitted from the camera and render the captured images.

2. The system of claim 1, wherein the display device is in operable communication with the camera via a wired connection.

3. The system of claim 1, wherein the display device is in operable communication with the camera via a wireless connection.

4. The system of claim 1, wherein the display device is permanently installed in a cockpit of the aircraft.

5. The system of claim 1, wherein the display device is a portable device.

6. The system of claim 5, wherein the portable device is a hand-held device.

7. The system of claim 1, wherein the camera is a thermal camera.

8. The system of claim 1, further comprising memory coupled to receive and store the digital image data.

9. The system of claim 8, wherein the memory is disposed within the camera.

10. The system of claim 8, wherein the memory is disposed remotely from the camera.

11. An aircraft, comprising:
a fuselage;
a first aircraft wing extending from the fuselage;
a second aircraft wing extending from the fuselage;
a first housing mounted on the fuselage;
a first light source disposed within the first housing and operable, upon being electrically energized, to emit a first light beam toward the first aircraft wing;
a first camera disposed within the first housing, the first camera configured to (i) capture first images of the first aircraft wing, (ii) convert the captured first images of the first aircraft wing to first digital image data, and (iii) transmit the first digital image data;
a second housing mounted on the fuselage;
a second light source disposed within the second housing and operable, upon being electrically energized, to emit a second light beam toward the second aircraft wing;
a second camera disposed within the second housing, the second camera configured to (i) capture second images of the second aircraft wing, (ii) convert the captured second images of the second aircraft wing to second digital image data, and (iii) transmit the second digital image data; and
a display device disposed remote from, and in operable communication with, the first and second cameras, the display device configured to receive the first and second digital image data transmitted from the first and second cameras, respectively, and render the first and second captured images.

12. The aircraft of claim 11, wherein the display device is in operable communication with the camera via a wired connection.

13. The aircraft of claim 11, wherein the display device is in operable communication with the camera via a wireless connection.

14. The aircraft of claim 11, wherein the display device is permanently installed in a cockpit of the aircraft.

15. The aircraft of claim 11, wherein the display device is a portable device.

16. The aircraft of claim 15, wherein the portable device is a hand-held device.

17. The aircraft of claim 11, wherein the camera is a thermal camera.

18. The aircraft of claim 11, further comprising memory coupled to receive and store the digital image data.

19. The aircraft of claim 18, wherein the memory comprises:
a first memory disposed within the first camera; and
a second memory disposed within the second camera.

20. The aircraft of claim 18, wherein the memory is disposed remotely from the camera.
